(19) United States
(12) Patent Application Publication
(10) Pub. No.: US 2008/0001522 A1
(43) Pub. Date: Jan. 3, 2008

(54) Spiral-Wound Filament for an Incandescent Lamp and Incandescent Lamp

(75) Inventors: Frank Glockler, Schernfeld (DE); Christoph Krieglmeyer, Hitzhofen/Hofstetten (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHL, Munchen (DE)

(21) Appl. No.: 11/579,157

(22) PCT Filed: May 2, 2005
(86) PCT No.: PCT/DE05/00808

§ 371 Date: Oct. 31, 2006

(30) Foreign Application Priority Data
May 12, 2004 (DE) 10 2004 023 935.5

(51) Int. Cl. H01K 1/14; H01K 1/18; H01K 1/32; H01K 3/06

(52) U.S. Cl. 313/498

(57) ABSTRACT

A spiral-wound filament (110) for an incandescent lamp, includes two lead-in wires (1102, 1103), the lead-in wires (1102, 1103) having one bent limb (11021, 11031) each which are arranged in a joint plane that extends off-set in parallel to the winding axis (1104) of the spiral-wound filament (110). An incandescent lamp that has an axially symmetric lamp base (100) and a spiral-wound filament (110) that is off-set in parallel to the lamp base axis (A-A) is also disclosed.

The invention relates to an incandescent filament for an incandescent lamp in accordance with the precharacterizing clause of patent claim 1 and to an incandescent lamp having such an incandescent filament.

### PRIOR ART

Such an incandescent filament is disclosed, for example, in the European laid-open specification EP 1 255 279 A2. This specification describes a halogen incandescent lamp, whose dimensions are at maximum only 6 mm transversely with respect to its longitudinal extent. This lamp is envisaged for use in a torch. The incandescent filament of this halogen incandescent lamp has two outgoing filament sections, which are each welded to a power supply wire.

### SUMMARY OF THE INVENTION

It is the object of the invention to provide an incandescent filament for an incandescent lamp, which can be fixed with a parallel offset with respect to the lamp vessel axis in a manner which is as simple as possible within an axially symmetrical lamp vessel. In addition, it is the object of the invention to provide an incandescent lamp having a corresponding incandescent filament.

This object is achieved according to the invention by the features of patent claim 1. Particularly advantageous embodiments of the invention are described in the dependent patent claims.

The two outgoing filament sections of the incandescent filament according to the invention each have a bent-back limb, which are arranged in a common plane running with a parallel offset with respect to the winding axis of the incandescent filament. As a result, it is possible without any additional measures to realize an axial alignment of the incandescent filament, with a parallel offset with respect to the axis of symmetry of the lamp vessel, in an axially symmetrical lamp vessel, which is sealed at one end. For this purpose, it is sufficient that the bent-back outgoing filament sections are each connected to a power supply part embedded in the sealed end of the lamp vessel. In particular, it is therefore possible to dispense with a frame for holding the incandescent filament in the lamp vessel.

The two outgoing filament sections of the incandescent filament according to the invention are preferably each L-shaped. That is to say each outgoing filament section is only bent back once, to be precise at a right angle. A first L limb of each outgoing filament section is connected to that region of the incandescent filament which is responsible for the light emission, while a second L limb thereof is bent back at a right angle, with the result that these second L limbs of the two outgoing filament sections are arranged in a common plane running with a parallel offset with respect to the winding axis of the incandescent filament.

The incandescent filament according to the invention is particularly well suited to use in incandescent lamps, preferably halogen incandescent lamps, which have an axially symmetrical lamp vessel provided with a light-reflecting coating and an axially aligned incandescent filament, which is arranged with a parallel offset with respect to the lamp vessel axis, for the purpose of directed light emission.

The incandescent lamp according to the invention has an axially symmetrical, transparent lamp vessel, which is sealed off at one end and is provided with current leadthroughs, as well as an incandescent filament, which is aligned axially in the lamp vessel and is arranged with a parallel offset with respect to the lamp vessel axis, the incandescent filament having two outgoing filament sections, each having a bent-back limb, which are arranged in a common plane running with a parallel offset with respect to the winding axis of the incandescent filament, and the bent-back limbs each being connected to a power supply part embedded in the sealed end of the lamp vessel. As a result, reliable, eccentric holding of the incandescent filament in the lamp vessel is ensured without any additional measures. In particular, a complex frame structure for holding the filament is not required.

The power supply parts which are embedded in the sealed end of the lamp vessel and to which the bent-back limbs are connected are advantageously each a metal foil, in particular a molybdenum foil, which are used, on the one hand, as the power supply line for the incandescent filament and, on the other hand, are suitable for sealing the lamp vessel since they can be fused in a gas-tight manner in the sealed end of the lamp vessel.

The lamp vessel of the incandescent filament according to the invention is preferably provided with a light-reflecting coating, which extends over part of the circumference of the lamp vessel, and the incandescent filament is preferably arranged with a parallel offset with respect to the lamp vessel axis in the direction of the light-reflecting coating in order to achieve a directed light emission at a preferred solid angle.

### DESCRIPTION OF THE PREFERRED EXEMPLARY EMBODIMENT

The invention will be explained in more detail below with reference to a preferred exemplary embodiment. In the drawing:

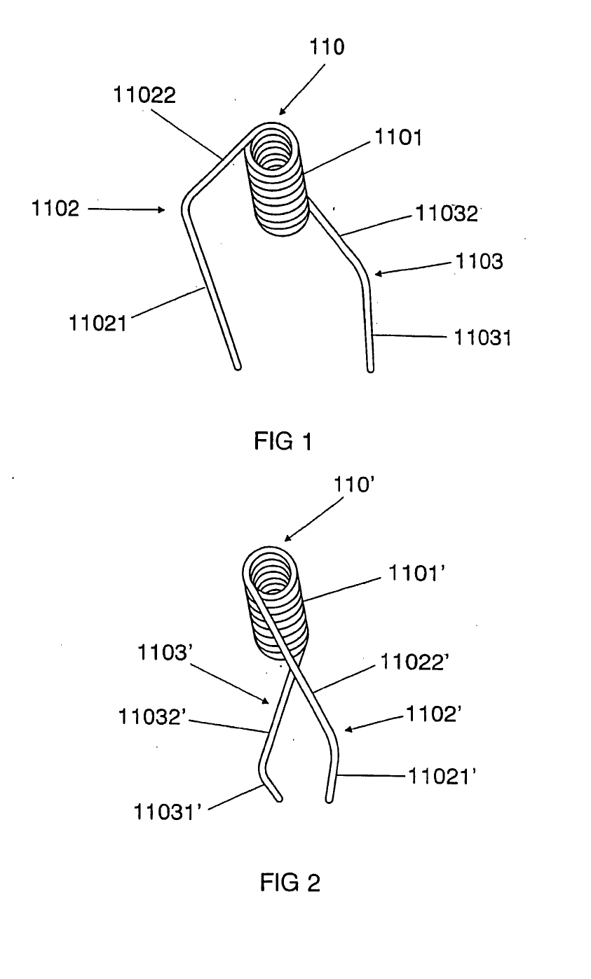

FIG. 1 shows an incandescent filament for an incandescent lamp in accordance with the first exemplary embodiment of the invention,

FIG. 2 shows an incandescent filament for an incandescent lamp in accordance with the second exemplary embodiment of the invention,

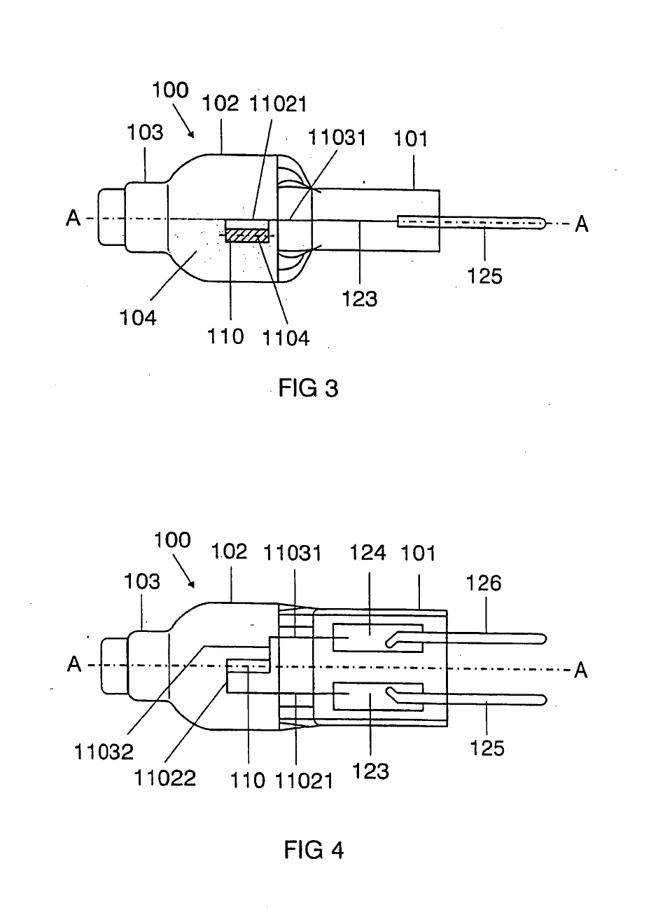

FIG. 3 shows a side view of an incandescent lamp in accordance with the preferred exemplary embodiment of the invention, in a schematic illustration, and

FIG. 4 shows a schematic illustration of the incandescent lamp depicted in FIG. 3 in a side view rotated through an angle of 90° about the longitudinal axis in comparison with FIG. 3.

The incandescent filaments 110 and 110′ depicted in FIGS. 1 and 2 are incandescent filaments with a single turn consisting of tungsten wire which are provided for a low-voltage halogen incandescent lamp having an electrical power consumption of approximately 20 watts. These incandescent filaments 110 and 110′ have a coiled region 1101 and 1101′, respectively, which is responsible for the light emission and two uncoiled outgoing filament sections 1102, 1103 and 1102′, 1103′, respectively, associated therewith. These outgoing filament sections 1102, 1103 and 1102′, 1103′ each have a bent-back limb 11021, 11031 and 11021′, 11031′, respectively. The bent-back limbs 11021, 11031 of the two outgoing filament sections 1102, 1103 are arranged in a common plane running with a parallel offset with respect to the winding axis of the incandescent filament 110. In addition, the two limbs 11021, 11031 also run parallel to one another. An analogous statement also applies to the bent-back limbs 11021′, 11031′ of the two outgoing filament sections 1102′, 1103′ of the incandescent filament 110′ in accordance with the second exemplary embodiment. The outgoing filament sections 1102, 1103 and 1102′, 1103′ of the incandescent filament 110 and 110′, respectively, are L-shaped, that is to say they are bent back only once at a right angle. A first L limb 11022, 11032 and 11022′, 11032′ is connected directly to that region 1101 and 1101′, respectively, of the incandescent filament 110 and 110′, respectively which is responsible for the light emission, while the second L limb 11021, 11031 and 11021′, 11031′, respectively, is bent back at a right angle from the respective first L limb.

The second L limbs 11021, 11031 of the two outgoing filament sections of the incandescent filament 110 are in each case welded to a molybdenum foil 123, 124, which is embedded in the sealed end 101 of the lamp vessel 100, of the halogen incandescent lamp depicted in FIGS. 3 and 4. A similar statement also applies to the L limbs 11021′, 11031′ of the outgoing filament sections of the incandescent filament 110′ in accordance with the second exemplary embodiment if this is used instead of the incandescent filament 110 in the lamp.

The incandescent filaments 110, 110′ each have an outer diameter of 2.27 mm and their coil which is responsible for the light emission has a length of 4.19 mm. These incandescent filaments are designed for a rated voltage of 12 volts and an electrical power of 20 watts.

The two incandescent filaments 110, 110′ differ from each other only by the angle enclosed by the first L limbs 11022, 11032 and 11022′, 11032′, respectively, of the two outgoing filament sections of the respective incandescent filament.

The exemplary embodiment of the incandescent lamp according to the invention depicted in FIGS. 3 and 4 is a halogen incandescent lamp having an electrical power consumption of approximately 20 watts. This lamp has a lamp vessel 100 consisting of quartz glass, which is sealed in a gas-tight manner at one end by means of a pinch seal 101. The lamp vessel 100 also has a circular-cylindrical vessel section 102 and an exhaust tube attachment 103, which is arranged diametrically with respect to the pinch seal 101. An incandescent filament 110 as shown in FIG. 1 is arranged within the lamp vessel 100. The bent-back limbs 11021, 11031 of its two outgoing filament sections are each connected to a molybdenum foil 123, 124, which is embedded in a gas-tight manner in the pinch seal 101. The molybdenum foils 123, 124 are each connected to a contact pin 125, 126, which protrudes out of the pinch seal 101, of the halogen incandescent lamp. The circular-cylindrical vessel section 102 is provided on its outer surface with a light-reflecting coating 104. The coating 104 extends over 50 percent of the circumference of the circular-cylindrical vessel section 102 and reaches up to the exhaust tube attachment 103. In other words, the coating 104 covers a half-shell of the cylindrical lamp vessel section 102 and is extended up to the exhaust tube attachment 103. The coating 104 consists of a first light-reflecting silver layer applied directly to the surface of the lamp vessel, a second opaque chromium layer applied thereto and a third SiO₂ protective layer arranged on the chromium layer. The incandescent filament 110 is aligned axially and is arranged with a parallel offset with respect to the cylinder axis A-A of the circular-cylindrical vessel section 102. The outer diameter of the lamp vessel 100 is 9.5 mm and its wall thickness is 1 mm. The axis 1104 of the incandescent filament 110, which is identical to its winding axis, is displaced, parallel, through 2 mm with respect to the cylinder axis A-A in the direction of the coating 104. The two bent-back limbs 11021 and 11031 of the outgoing filament sections of the incandescent filament 110 are welded to the molybdenum foil 123 and 124, respectively. In addition, the two bent-back limbs 11021 and 11031 are arranged in a common plane, i.e. in the plane of the molybdenum foils 123, 124, which also contains the cylinder axis A-A, and run parallel to one another. The axis, i.e. the winding axis 1104 of the incandescent filament 110, is arranged with a parallel offset through 2 mm with respect to the cylinder axis A-A outside the abovementioned plane. In the orientation in FIG. 3, the winding axis 1104 of the incandescent filament 110 runs approximately 2 mm beneath the plane defined by the bent-back limbs 11021 and 11031. The pinch seal 101 is arranged in a G4 base (not depicted).

The invention is not restricted to the exemplary embodiments of the invention explained in more detail above. For example, a so-called cold-light mirror, which is transparent to infrared radiation and reflects electromagnetic radiation from the visible spectral range, can also be used instead of the above-described coating 104. The two bent-back L limbs 11021, 11031, which are arranged in a common plane, do not necessarily need to run parallel to one another, but their distance from one another can increase, for example, in the direction of the molybdenum foils 123, 124. In addition, the invention can also be applied to incandescent lamps and incandescent filaments of other rating classes than 20 watts.

1. An incandescent filament for an incandescent lamp, the incandescent filament (110) having two outgoing filament sections (1102, 1103), characterized in that the two outgoing filament sections (1102, 1103) each have a bent-back limb (11021, 11031), which are arranged in a common plane which runs with a parallel offset with respect to the winding axis (1104) of the incandescent filament (110).

2. The incandescent filament as claimed in claim 1, characterized in that the outgoing filament sections (1102, 1103) are each L-shaped.

3. The incandescent filament as claimed in claim 2, characterized in that each outgoing filament section (1102, 1103) has a first L limb (11022, 11032), which is connected to that region (1101) of the incandescent filament (110) which is responsible for the light emission, and has a second L limb (11021, 11031), which is bent back at a right angle, these second L limbs (11021, 11031) being the bent-back limbs of the two outgoing filament sections (1102, 1103) which are arranged in the common plane running with a parallel offset with respect to the winding axis of the incandescent filament (110).

4. An incandescent lamp having at least one incandescent filament as claimed in claim 1.

5. An incandescent lamp having a transparent, axially symmetrical lamp vessel (100), which is sealed off at one end (101) and is provided with current leadthroughs (123, 124, 125, 126), and an incandescent filament (110) arranged within the lamp vessel (100) as claimed in claim 1, characterized in that the incandescent filament (110) is aligned axially in the lamp vessel (100) and is arranged with a parallel offset with respect to the lamp vessel axis (A-A), the bent-back limbs (11021, 11031) of the two outgoing filament sections (1102, 1103) each being connected to a power supply part (123, 124) embedded in the sealed end (101) of the lamp vessel (100).

6. The incandescent lamp as claimed in claim 5, characterized in that the power supply part (123, 124) is in each case a metal foil embedded in a gas-tight manner in the sealed lamp vessel end (101).

7. The incandescent lamp as claimed in claim 5, characterized in that the lamp vessel (100) is provided with a light-reflecting coating (104), which extends over part of the circumference of the lamp vessel (100), the incandescent filament (110) being arranged with a parallel offset with respect to the lamp vessel axis (A-A) in the direction of the light-reflecting coating (104).

8. An incandescent lamp having at least one incandescent filament as claimed in claim 2.

9. An incandescent lamp having at least one incandescent filament as claimed in claim 3.

10. An incandescent lamp having a transparent, axially symmetrical lamp vessel (100), which is sealed off at one end (101) and is provided with current leadthroughs (123, 124, 125, 126), and an incandescent filament (110) arranged within the lamp vessel (100) as claimed in claim 2, characterized in that the incandescent filament (110) is aligned axially in the lamp vessel (100) and is arranged with a parallel offset with respect to the lamp vessel axis (A-A), the bent-back limbs (11021, 11031) of the two outgoing filament sections (1102, 1103) each being connected to a power supply part (123, 124) embedded in the sealed end (101) of the lamp vessel (100).

11. An incandescent lamp having a transparent, axially symmetrical lamp vessel (100), which is sealed off at one end (101) and is provided with current leadthroughs (123, 124, 125, 126), and an incandescent filament (110) arranged within the lamp vessel (100) as claimed in claim 3, characterized in that the incandescent filament (110) is aligned axially in the lamp vessel (100) and is arranged with a parallel offset with respect to the lamp vessel axis (A-A), the bent-back limbs (11021, 11031) of the two outgoing filament sections (1102, 1103) each being connected to a power supply part (123, 124) embedded in the sealed end (101) of the lamp vessel (100).

12. The incandescent lamp as claimed in claim 6, characterized in that the lamp vessel (100) is provided with a light-reflecting coating (104), which extends over part of the circumference of the lamp vessel (100), the incandescent filament (110) being arranged with a parallel offset with respect to the lamp vessel axis (A-A) in the direction of the light-reflecting coating (104).
